(19) United States
(12) Patent Application Publication
(10) Pub. No.: US 2013/0335363 A1
(43) Pub. Date: Dec. 19, 2013

(54) ELECTRONIC SYSTEM AND THE CONTROL METHOD THEREIN

(71) Applicant: LIN HUNG-YI, New Taipei City (TW)

(72) Inventor: LIN HUNG-YI, New Taipei City (TW)

(73) Assignee: IDEACOM TECHNOLOGY INC., New Taipei City (TW)

(21) Appl. No.: 13/527,097

(22) Filed: Jun. 19, 2012

(51) Int. Cl. G06F 3/041; G06F 3/044; G06F 3/045

(52) U.S. Cl. 345/174; 345/173; 178/18.03

(57) ABSTRACT

The invention relates to an electronic system comprising a touch module and a control module. The touch module includes at least one sensing unit and a touch panel for sensing input operations executed by a user respectively and generates at least one sensing signal or at least one touching signal correspondingly. The control module coupled to the touch module is used for disabling the touch panel according to the at least one sensing signal or executing operations according to the at least one touching signal.

### BACKGROUND OF THE INVENTION

1. Field of the Invention

The invention is related to an electronic system, and more specifically related to an electronic system for preventing from error operations via unintended touching the touch panel by the user.

2. Description of the Prior Art

According to the development of touch sensing technology, various kinds of electronic systems including touch panel are designed for the people. Taking the mobile phone for example, it has been a popular electronic product cannot be ignored in the daily life for most people. Wherein, the touch panel was implement in various kinds' electronic productions because of it has advantages of small size, low cost, low power consumption and long usage time period.

Most of mobile communication devices include touch panel for providing the operation interface to the user, however, those mobile communication devices have problems that the user may unintended touch the touch panel when using, just like the face, the ear, the finger or the palm of the user unintended touches the touch panel, at this moment, those mobile communication devices will execute error operations. In order to prevent the error operations described above, mobile communication device usually set an external sensor on specific position of the mobile communication devices, when the external sensor senses the face of the user moving near the mobile communication device, it will close the touch panel automatically until the face of the user moving away from the mobile communication device, and then the touch panel will be enabled again to recover the normal mode. The sensing manner described above needs to set an external sensor on the mobile communication device, it has disadvantages that not only increase the cost but also complexes the production process of the mobile communication device.

Therefore, how to provide an electronic system can prevent from unintended touching the touch panel and executing the error operations has been an important matter for equipment factory in developing the electronic system including the touch panel.

### SUMMARY OF THE INVENTION

It is therefore a primary objective of the present invention to provide an electronic system suited in preventing from error operations caused by unintended touching the touch panel by the user.

One embodiment of the present invention provides an electronic system comprising a touch module and a control module. The touch module comprises at least one sensing unit and a touch panel for sensing input operations executed by a user and generates at least one sensing signal or at least one touching signal correspondingly. The control module coupled to the touch module is used for disabling the touch panel according to the at least one sensing signal or executing operations according to the at least one touching signal.

Another embodiment of the present invention provides an control method of an electronic system, wherein the electronic system includes at least one sensing unit and a touch panel, the control method including following steps: (a) sensing input operations via the at least one sensing unit and the touch panel respectively and generating at least one sensing signal or at least one touching signal correspondingly; (b) when the at least one sensing unit generating the at least one sensing signal, disabling the touch panel; or when the touch panel generating the at least one touching signal, executing operations corresponding to the at least one touching signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embodiment of an electronic system according to the present invention.

FIG. 2 is a flow diagram of an embodiment of a control method of an electronic system according to the present invention.

### DETAILED DESCRIPTION

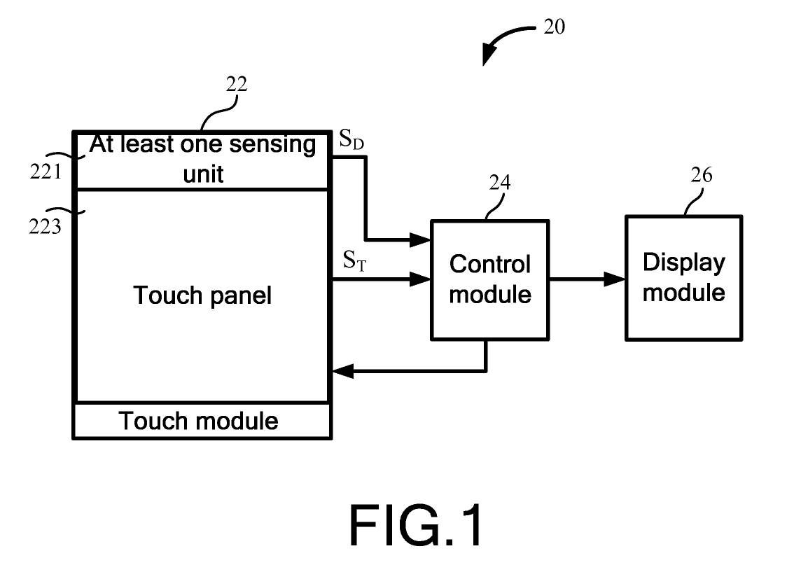

Please refer to FIG. 1. FIG. 1 is a schematic diagram of an embodiment of an electronic system according to the present invention. As shown in FIG. 1, the present invention provides an electronic system 20 comprises a touch module 22, a control module 24 and a display module 26. The touch module 22 includes at least one sensing unit 221 and a touch panel 223 for sensing input operations executed by a user respectively and generates at least one sensing signal S_{C} or at least one touching signal S_{T} correspondingly. The control module 24 coupled to the touch panel 22 is used for disabling the touch panel 223 according to the at least one sensing signal S_{D} or executing operations according to the at least one touching signal S_{T}.

The display module 26 coupled to the control module 24 is used for displaying frames controlled by the control module 24 of the electronic system 20. The control module 24 further disables the display module 26 according to the at least one sensing signal S_{D}. When the display module 26 has been disabled and the at least one sensing unit 221 does not continued generate the at least one sensing signal S_{D}, the control module 24 executes operation for enabling the display module 26. Similarly, when the touch panel 223 has been disabled and the at least one sensing unit 221 does not continued generate the at least one sensing signal S_{D}, the control module 24 executes operation for enabling the touch panel 223. Wherein, the position of display module 26 in the FIG. 1 is used for describing the connection relation of the electronic system 20, and the display module 26 is the LCD monitor of the touch panel in general. In an actual embodiment, the actual position of the display module 26 is located under the touch panel 223.

The at least one sensing unit 221 and the touch panel 223 of the touch module 22 of the electronic system 20 are located on the same touch panel substrate. In one embodiment, the at least one sensing unit 221 generates the at least one sensing signal S_{D} corresponding to the input operations of the user under a first sensing manner. The touch panel 223 generates the at least one touching signal S_{T} according to the input operations under a second sensing manner. Wherein, the touch panel 223 of the touch module 22 is a capacitive touch panel and the at least one sensing unit 221 of the touch module 22 is a capacitive keypad in the embodiment. The controller of touch panel comprises a plurality of channels for sensing each of the sensing units correspondingly. According to the design that taking the capacitive touch panel as the touch panel 223 of the touch module 22 and taking the capacitive keypad as the at least one sensing unit 221 of the touch module 22 for example, the controller of the capacitive touch panel and the capacitive keypad can be integrated together instead of separating to each other. At this embodiment, the capacitive keypad can execute the sensing operations via only one channel of those pluralities channels of the controller of the capacitive touch panel. According to the sensing manner described above, it reaches the purpose to saving the cost and simply the production process than the sensing manner using the external controller in the prior art. Furthermore, the user can utilities those two sensing manners described above according to the actual implements.

The following descriptions are using for explaining the embodiment of the at least one sensing unit 221 and the touch panel 223 of the touch panel 22 for generating the at least one sensing signal S_{D} or the at least one touching signal S_{T} correspondingly. When the user touches the at least one sensing unit 221 or touching both the at least one sensing unit 221 and the touch panel 223 at the same time, the touch module 22 generates the at least one sensing signal S_{D} correspondingly. If the user touches the touch panel 223, the touch module 22 generates the at least one touching signal S_{T} correspondingly. In one embodiment, when the at least one sensing unit 221 generates the at least one sensing signal S_{D}, the control module 24 will disable the touch panel 223 for rejecting the operations executed by the user and does not generate the touching signal S_{T} correspondingly. When the control module 24 does not continued receive the at least one sensing signal S_{D} generated by the touch module 22, it enables the touch panel 223 for providing an operation interface to the user again.

The following description is used for explaining the operation manner of the electronic system 20 according to this invention, the electronic system 20 is a mobile communication device or a smart phone, the at least one sensing unit 221 is capacitive keypad adjacent to speaker of the smart phone, the touch panel 223 is a capacitive touch panel, and the display module 26 is the LCD monitor of the smart phone in this embodiment. When the user executes operations on the touch panel 223, it generates the at least one touching signal S_{T} and then the control module 24 executes operations correspondingly, for example: those functions of the smart phone in general just like answering a phone call, ending a phone call or dialing a phone number. However, taking the smart phone is under a communication mode that the user is on a phone call for example, the habit of the user in general is that putting the smart phone near the ear of the face for communicating to the phone caller via the speaker of the smart phone. At this moment, the ear or the face of the user may touch the at least one sensing unit 221 (capacitive keypad) located near the speaker or touch the at least one sensing unit 221 and the touch panel 223 at the same time, that causing the touch module 24 generating the at least one sensing signal S_{D} correspondingly and then the control module 24 disables the touch panel 223 and the LCD monitor of the smart phone according to the at least one sensing signal S_{D} correspondingly. According to the design of the electronic system 20 for disabling the touch panel 223 and the LCD monitor not only can save power of the smart phone but also preventing the touch panel 223 from error operations caused by unintended touching the touch panel 223. When the user ends the phone call, the ear or the face of the user will separating from the at least one sensing unit 221 and the touch module 24 will not continued generate the at least one sensing signal S_{D}, the LCD monitor will be enabled instead of disabled to execute the operation for displaying frames, besides the touch panel is also enabled for providing user an operation interface to control the smart phone.

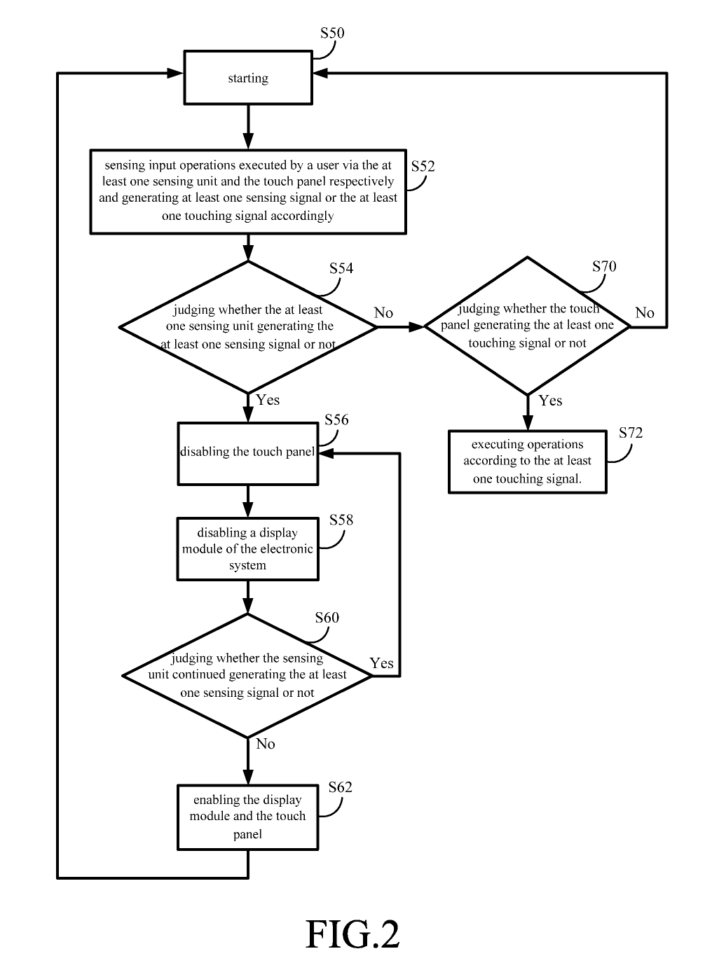

Please refer to FIG. 2. FIG. 2 is a flow diagram of an embodiment of a control method of an electronic system according to the present invention. As shown in FIG. 2, the electronic system includes a touch module comprising at least one sensing unit and a touch panel according to the invention. The control method of the electronic system according to the present invention comprises following steps:

S50: starting;

S52: sensing input operations executed by a user via the at least one sensing unit and the touch panel respectively and generating at least one sensing signal or the at least one touching signal accordingly;

In one embodiment, when the user touches the at least one sensing unit or touches the at least one sensing unit and the touch panel at the same time, this step of the control method generates the at least one sensing signal; otherwise when the user touches the touch panel only, this step generates the at least one touching signal correspondingly.

S54: judging whether the at least one sensing unit generating the at least one sensing signal or not, if yes, going to step S56; otherwise, going to step S70.

S56: disabling the touch panel; and

S58: disabling a display module of the electronic system.

When the touch panel and the display module are disabled by the step S56 and the step S58 description above, the control method of the electronic system further comprises following steps:

S60: judging whether the at least one sensing unit continued generating the at least one sensing signal or not; if yes, going to the step S56 and the step S58; otherwise, going to step S62.

S62: enabling the display module and the touch panel and then returning to the step S50.

S70: judging whether the touch panel generating the at least one touching signal or not; if yes, going to step S72; if not, turning back to the step S50.

S72: executing operations according to the at least one touching signal.

The electronic system according to the present invention utilities the sensing manner that using the capacitive keypad as the sensing unit for sensing the ear or the face of the user, it only uses one of the pluralities of channels of the capacitive touch panel to reach the purpose of sensing the ear or the face of the user. The sensing manner described above not only improves the disadvantages of the high cost and complex production process of the sensing manner using external sensor in the prior art but also reaches the purpose of full plane at the outward appearance. As mentioned above, the electronic system and the control method therein of this invention provides an electronic system and control method that can prevent from error operations via unintended touching the touch panel of the electronic system by the user without setting any other external component which is the advantage of this invention.

Those skilled in the art will readily observe that numerous modifications and alterations of the apparatus and the method may be made while retaining the teachings of the invention. Accordingly, the above disclosure should be construed as limited only by the metes and bounds of the appended claims.

What is claimed is:

1. An electronic system, comprising:
a touch module including at least one sensing unit and a touch panel for sensing input operations executed by a user respectively and generating at least one sensing signal or at least one touching signal correspondingly; and
a control module coupled to the touch module for disabling the touch panel according to the at least one sensing signal or executing operations according to the at least one touching signal correspondingly.

2. The electronic system of claim 1, wherein the control module further comprises a display module for displaying frames.

3. The electronic system of claim 2, wherein the control module further disables the display module according to the at least one sensing signal.

4. The electronic system of claim 3, wherein when the display module is disabled and the at least one sensing unit does not continued generate the at least one sensing signal, the control module enables the display module.

5. The electronic system of claim 1, wherein when the touch panel is disabled and the at least one sensing unit does not continued generate the at least one sensing signal, the control module enables the touch panel.

6. The electronic system of claim 1, wherein when the user touches the at least one sensing unit or touches both the at least one sensing unit and the touch panel, the touch module generates the at least one sensing signal.

7. The electronic system of claim 6, wherein when the user touches the touch panel only, the touch panel generates the at least one touching signal.

8. The electronic system of claim 1, wherein the at least one sensing unit senses the input operations of the user under a first sensing manner and the touch panel senses the input operations of the user under a second sensing manner.

9. The electronic system of claim 8, wherein the at least one sensing unit is a capacitive touch keypad and the touch panel is a capacitive touch panel or a resistive touch panel.

10. The electronic system of claim 1, wherein the electronic system is a mobile communication device.

11. A control method of an electronic system which including at least one sensing unit and a touch panel, the control method comprising following steps:
(a) sensing input operations executed by a user via the at least one sensing unit and the touch panel respectively and generating at least one sensing signal or the at least one touching signal correspondingly; and
(b) when the at least one sensing unit generating the at least one sensing signal, disabling the touch panel, or when the touch panel generating the at least one touching signal, executing operations corresponding to the at least one touching signal.

12. The control method of an electronic system of claim 11, wherein the electronic system further includes a display module for displaying frames, and the control method further comprises following step:
(C) disabling the display module according to the at least one sensing signal.

13. The control method of an electronic system of claim 12, wherein when the display module is disabled and the at least one sensing unit does not continued generate the at least one sensing signal, the control method enables the display module.

14. The control method of an electronic system of claim 11, wherein when the touch panel is disabled and the at least one sensing unit does not continued generate the at least one sensing signal, the control method enables the touch panel.

15. The control method of an electronic system of claim 14, wherein when the user touches the at least one sensing unit or touches both the at least one sensing unit and the touch panel, the step (a) generates the at least one sensing signal.

16. The control method of an electronic system of claim 15, wherein when the user touches the touch panel only, the step (a) generates the at least one touching signal.

17. The control method of an electronic system of claim 11, wherein the at least one sensing unit senses the input operations of the user under a first sensing manner and the touch panel senses the input operations of the user under a second sensing manner.
